(19) United States
(12) Patent Application Publication
(10) Pub. No.: US 2012/0160029 A1
(43) Pub. Date: Jun. 28, 2012

(54) ACCELERATION SENSOR

(75) Inventors: Yasuo YAMAGUCHI, Tokyo (JP); Mika Okumura, Tokyo (JP); Takeshi Murakami, Tokyo (JP)

(73) Assignee: MITSUBISHI ELECTRIC CORPORATION, Chiyoda-ku (JP)

(21) Appl. No.: 13/197,104

(22) Filed: Aug. 3, 2011

(30) Foreign Application Priority Data
Dec. 27, 2010 (JP) 2010-289508

(51) Int. Cl. G01P 15/125; G01P 15/00

(52) U.S. Cl. 73/514.32; 73/514.16

(57) ABSTRACT

An acceleration sensor of the present invention comprises a first mass body which is held by first beams and can be displaced by acceleration, fixed electrodes which are so arranged as to convert the displacement of the first mass body into the quantity of electricity, and a displaceability changing member for changing the displaceability of the first mass body when the displacement of the first mass body exceeds a predetermined range.

### BACKGROUND OF THE INVENTION

1. Field of the Invention

The present invention relates to an acceleration sensor which is capable of detecting a physical quantity such as acceleration, angular velocity, or the like by supporting a mass body on a substrate in a displaceable manner and detecting the displacement of the mass body, and the present invention can be applied to, for example, a comb-teeth type capacitance sensor or the like.

2. Description of the Background Art

There have been used acceleration sensors using MEMS (Micro Electro Mechanical Systems).

In an acceleration sensor, a mass body and a fixed electrode are formed from a semiconductor substrate and these members are held by glass substrates or the like. The mass body is connected to a beam of which the end portion is fixed by an anchor. The mass body can be displaced. The acceleration sensor can sense acceleration by detecting the change of a capacitance generated between the mass body and the fixed electrode.

Prior arts relevant to acceleration sensors are shown in a plurality of documents (for example, Japanese Patent Application Laid Open Gazette No. 2008-190892 (Patent Document 1) and Japanese Patent Application Laid Open Gazette No. 2009-014598 (Patent Document 2)).

A prior-art acceleration sensor needs a plurality of acceleration sensor elements in order to cover various acceleration detection ranges. In a case where a plurality of acceleration sensor elements are needed, however, it becomes necessary to design and manufacture the acceleration sensor element for each acceleration range to be detected and this disadvantageously causes low manufacturing efficiency and complicated management.

Further, a high-acceleration detecting acceleration sensor element can detect low acceleration and a low-acceleration detecting acceleration sensor element can detect high acceleration. In the former case, however, in order to detect the low acceleration, it is necessary to increase an output voltage by using a control circuit, and noise is also increased with the output voltage and the S/N ratio is deteriorated. On the other hand, in the latter case, when the high acceleration is inputted to the low-acceleration detecting element, the amount of displacement of the mass body increases and the beam or/and the mass body may be thereby broken.

### SUMMARY OF THE INVENTION

It is an object of the present invention to provide an acceleration sensor which is capable of detecting wide range acceleration by using one acceleration sensor element.

The present invention is intended for an acceleration sensor. According to the present invention, the acceleration sensor includes a first mass body, a fixed electrode, and a displaceability changing member. In the acceleration sensor of the present invention, the first mass body is held by a first beam and can be displaced by acceleration. The fixed electrode is so arranged as to convert the displacement of the first mass body into the quantity of electricity. The displaceability changing member changes displaceability of the first mass body when the displacement of the first mass body exceeds a predetermined range.

Therefore, the acceleration sensor of the present invention is capable of detecting wide range acceleration (both a high acceleration region and a high acceleration region) by using one acceleration sensor element.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing a configuration of an acceleration sensor of an underlying technology;

FIG. 2 is a cross section taken along the cross-section line A-A of FIG. 1;

FIG. 3 is a plan view showing a configuration of an acceleration sensor in accordance with a first preferred embodiment;

FIG. 4 is a cross section taken along the cross-section line B-B of FIG. 3;

FIG. 5 is an enlarged plan view showing another exemplary configuration of the acceleration sensor in accordance with the first preferred embodiment;

FIG. 6 is an enlarged plan view showing a configuration of an acceleration sensor in accordance with a second preferred embodiment;

FIGS. 7 and 8 are graphs each showing acceleration and output sensitivity characteristic of the acceleration sensor of the present invention;

FIG. 9 is an enlarged plan view showing a configuration of an acceleration sensor in accordance with a third preferred embodiment;

FIG. 10 is an enlarged plan view showing another exemplary configuration of the acceleration sensor in accordance with the third preferred embodiment;

FIG. 11 is an enlarged plan view showing still another exemplary configuration of the acceleration sensor in accordance with the third preferred embodiment;

FIG. 12 is a plan view showing a configuration of an acceleration sensor in accordance with a fourth preferred embodiment;

FIG. 13 is a plan view showing another exemplary configuration of the acceleration sensor in accordance with the fourth preferred embodiment;

FIG. 14 is a plan view showing a configuration of an acceleration sensor in accordance with a fifth preferred embodiment;

FIG. 15 is an enlarged plan view used for explanation of an operation of the acceleration sensor in accordance with the fifth preferred embodiment;

FIG. 16 is an enlarged plan view showing another exemplary configuration of the acceleration sensor in accordance with the fifth preferred embodiment;

FIG. 17 is a plan view showing a configuration of an acceleration sensor in accordance with a sixth preferred embodiment;

FIGS. 18 and 19 are enlarged plan views used for explanation of an operation of the acceleration sensor in accordance with the sixth preferred embodiment; and

FIG. 20 is a plan view showing another exemplary configuration of the acceleration sensor in accordance with the sixth preferred embodiment.

### DESCRIPTION OF THE PREFERRED EMBODIMENTS

First, a technical premise of the present invention (referred to as an underlying technology) will be discussed with reference to figures.

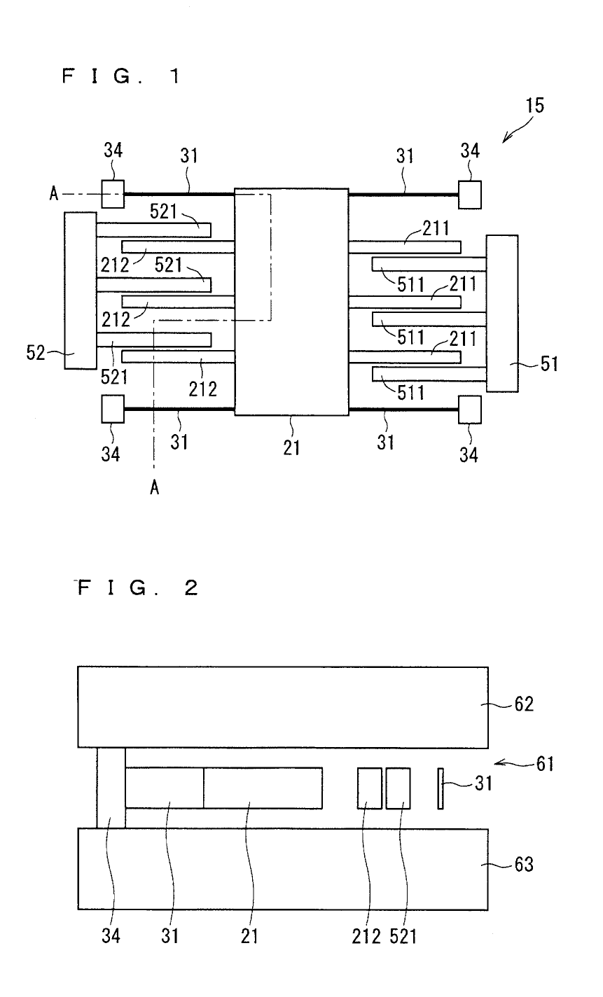

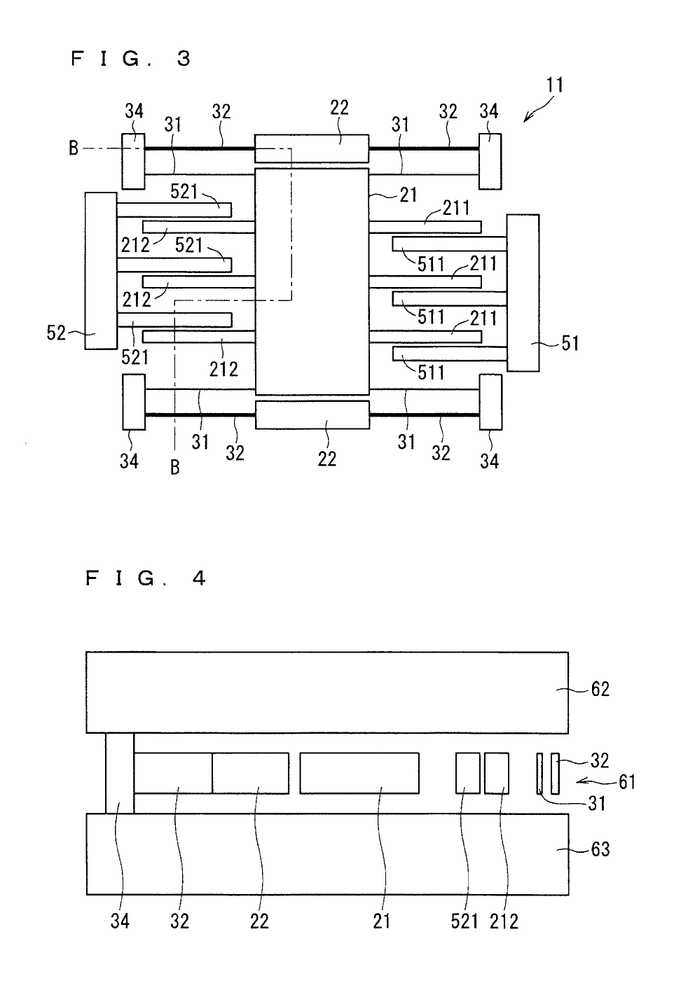

FIG. 1 is a plan view showing a configuration of an acceleration sensor of the underlying technology. FIG. 2 is a cross section taken along the cross-section line A-A of FIG. 1. In FIG. 1, for simple illustration, supporting substrates 62 and 63 are not shown.

In order to form an acceleration sensor element 15, a main board (motherboard) 61 made of a plate-like silicon substrate is processed by etching or the like using the MEMS (Micro Electro Mechanical Systems) technology into such a shape as shown in FIG. 1. The main board 61 is held between the supporting substrates 62 and 63 which are made of plate-like glass substrates (in other words, the acceleration sensor has a multilayer structure in which the supporting substrate 63, the main board 61, and the supporting substrate 62 are layered in this order).

Herein, the main board 61 is bonded to the supporting substrates 62 and 63 by, for example, anodic bonding. As the main board 61, a semiconductor other than silicon may be used. Further, as the supporting substrates 62 and 63, a material other than glass may be used.

The main board 61 is constituted of anchors 34, a mass body 21, fixed electrodes 51 and 52, and beams 31.

The mass body 21 is so supported by a plurality of beams 31 which can be elastically deformed as to be displaced (moved) by acceleration. Each of the beams 31 connects the mass body 21 to the corresponding one of the anchors 34 serving as a fixed end. Each of the anchors 34 is fixed to and supported by the supporting substrates 62 and 63. The mass body 21 is provided with comb-teeth electrodes 211 and 212 from two opposed sides thereof. Correspondingly to the electrodes 211 and 212, comb-teeth electrodes 511 and 521 are provided from the fixed electrodes 51 and 52. The fixed electrodes 51 and 52 are fixed to and supported by both or either of the supporting substrates 62 and 63.

When acceleration is inputted to the acceleration sensor element 15, the mass body 21 is displaced in a vertical (up and down) direction of FIG. 1 and the capacitance between the electrodes 211 and 511 and the capacitance between the electrodes 212 and 521 are changed. By detecting the changes of the capacitances, the acceleration sensor can sense the inputted acceleration. The output sensitivity with respect to the acceleration depends on the mass of the mass body 21 and the rigidity (beam width, beam length, beam thickness, and the number of beams) of the beam 31.

In the acceleration sensor of the underlying technology, different acceleration sensor elements 15 are used for various acceleration detection ranges. In a case of low acceleration detection of about 2 g (“g” represents acceleration of gravity: m/s²), for example, it is necessary to increase the detection sensitivity and in order to increase the detection sensitivity, the weight of the mass body 21 which is a movable part of the acceleration sensor element 15 has to be increased or the rigidity of the beam 31 which supports the mass body 21 has to be decreased (the beam length has to be increased, the beam width has to be decreased, or the like). On the other hand, in a case of high acceleration detection, the weight of the mass body 21 which is a movable part of the acceleration sensor element 15 has to be decreased or the rigidity of the beam 31 which supports the mass body 21 has to be increased (the beam length has to be decreased, the beam width has to be increased, or the like).

In other words, in order to cover various acceleration detection ranges, the acceleration sensor of the underlying technology needs a plurality of acceleration sensor elements 15. Then, it becomes necessary to design and manufacture the acceleration sensor element 15 for each acceleration range to be detected and this disadvantageously makes the manufacturing process complicated.

Hereafter, the acceleration sensor of the present invention will be specifically described with reference to figures showing the respective preferred embodiments.

### The First Preferred Embodiment

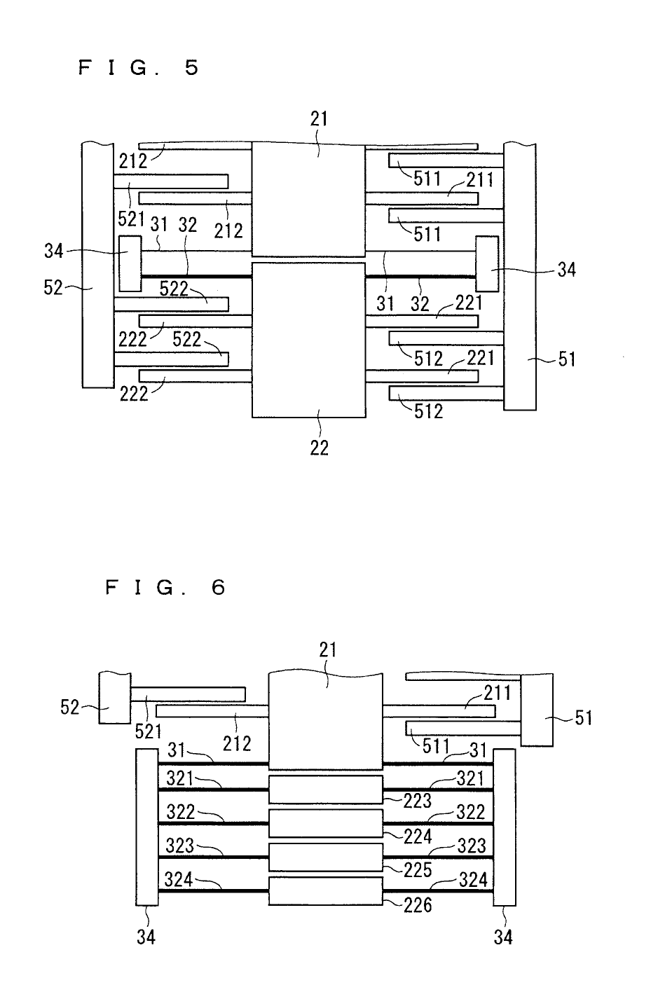

FIG. 3 is a plan view showing a configuration of an acceleration sensor in accordance with the first preferred embodiment. FIG. 4 is a cross section taken along the cross-section line B-B of FIG. 3. In FIG. 3, for simple illustration, the supporting substrates 62 and 63 are not shown.

In an acceleration sensor element 11 of the acceleration sensor, the main board 61 (see FIG. 4) made of a plate-like silicon substrate is processed by etching or the like using the MEMS technology into such a shape as shown in FIG. 3. As shown in FIG. 4, the main board 61 which is process thus is held between the supporting substrates 62 and 63 which are made of plate-like glass substrates. In other words, as shown in FIG. 4, the supporting substrate 63, the main board 61, and the supporting substrate 62 are layered in this order.

Herein, the main board 61 is bonded to the supporting substrates 62 and 63 by, for example, anodic bonding. As the main board 61, a semiconductor other than silicon may be used. Further, as the supporting substrates 62 and 63, a material other than glass may be used.

The main board 61 is constituted of the anchors 34, a first mass body 21, the fixed electrodes 51 and 52, a plurality of first beams 31, and a plurality of second beams 32.

The first mass body 21 is so supported by a plurality of first beams 31 which can be elastically deformed as to be displaced (moved) by the inputted acceleration. In the configuration of FIG. 3, provided are four first beams 31 and four anchors 34 serving as fixed ends. Each of the first beams 31 connects the first mass body 21 to the corresponding one of the anchors 34.

The anchors 34 are fixed to and supported by the supporting substrates 62 and 63. Therefore, the first beams 31 are supported by the supporting substrates 62 and 63 with the anchors 34 interposed therebetween.

As shown in FIG. 3, the first mass body 21 is provided with the comb-teeth electrodes 211 and 212 from two opposed sides thereof. The fixed electrode 51 is provided with the comb-teeth electrodes 511 from a side thereof which faces the first mass body 21, and the fixed electrode 52 is provided with the comb-teeth electrodes 521 from a side thereof which faces the first mass body 21.

As shown in FIG. 3, correspondingly to the comb-teeth electrodes 211, provided are the comb-teeth electrodes 511, and the comb-teeth electrodes 211 and the comb-teeth electrodes 511 are alternately arranged in a vertical (up and down) direction of FIG. 3. Very near each of the comb-teeth electrodes 211, provided is the corresponding one of the comb-teeth electrodes 511, and each of the comb-teeth electrodes 211 and the corresponding one of the comb-teeth electrodes 511 which is provided very near the comb-teeth electrode 211 are arranged away from each other with a first predetermined interval therebetween.

Further, as shown in FIG. 3, correspondingly to the comb-teeth electrodes 212, provided are the comb-teeth electrodes 521, and the comb-teeth electrodes 212 and the comb-teeth electrodes 521 are alternately arranged in the vertical (up and down) direction of FIG. 3. Very near each of the comb-teeth electrodes 212, provided is the corresponding one of the comb-teeth electrodes 521, and each of the comb-teeth electrodes 212 and the corresponding one of the comb-teeth electrodes 521 which is provided very near the comb-teeth electrode 212 are arranged away from each other with the first predetermined interval therebetween.

The fixed electrodes 51 and 52 are fixed to and supported by both or either of the supporting substrates 62 and 63. The fixed electrodes 51 and 52 are so arranged as to convert the displacement of the first mass body 21 into the quantity of electricity.

In the first preferred embodiment, as shown in FIGS. 3 and 4, two second mass bodies 22 are further provided in the main board 61. In FIG. 3, one of the second mass bodies 22 is so arranged as to face an upper side of the first mass body 21 and the other second mass body 22 is so arranged as to face a lower side of the first mass body 21. In this case, the first mass body 21 and each of the second mass bodies 22 are arranged away from each other with a second predetermined interval therebetween.

Each of the second mass bodies 22 is so supported by a plurality of second beams 32 which can be elastically deformed as to be displaced (moved) by the inputted acceleration. In the configuration of FIG. 3, two second beams 32 are provided for each of the second mass bodies 22. Each of the second beams 32 is connected to the corresponding one of the anchors 34 serving as a fixed end. Each of the second beams 32 connects the second mass body 22 to the corresponding one of the anchors 34.

As discussed above, the anchors 34 are fixed to and supported by the supporting substrates 62 and 63. Therefore, the second beams 32 are supported by the supporting substrates 62 and 63 with the anchors 34 interposed therebetween.

The acceleration sensor of the present invention comprises a displaceability changing member for changing the movability (or displaceability) of the first mass body 21 when the displacement of the first mass body 21 exceeds a predetermined range.

In the first preferred embodiment, the second mass bodies 22 which can be displaced by the acceleration while being held by the second beams 32 and are arranged away from the first mass body 21 with the second predetermined interval therebetween serve as the displaceability changing member.

In the acceleration sensor element 11 of the acceleration sensor in accordance with the first preferred embodiment, when acceleration is inputted, the first mass body 21 is displaced in the vertical (up and down) direction of FIG. 3 and the capacitance between the electrode 211 and the electrode 511 and the capacitance between the electrode 212 and the electrode 521 are changed. By detecting the changes of the capacitances, the acceleration sensor can sense the inputted acceleration. The output sensitivity with respect to the acceleration depends on the mass of the mass body and the rigidity (beam width, beam length, beam thickness, and the number of beams) of the beam.

The noticeable characteristic feature of the acceleration sensor of the first preferred embodiment is that the dimension of the first beams 31 (the rigidity of the beams, i.e., the beam width, the beam length, the beam thickness, and the number of beams) is determined so that the first mass body 21 may be displaced in the low acceleration region.

In the first preferred embodiment, when high acceleration is inputted to the acceleration sensor element 11, the first mass body 21 is largely moved to be brought into contact with the second mass bodies 22. With the contact between the first mass body 21 and the second mass bodies 22, the second beams 32 having high rigidity affect the movement (movability) of the first mass body 21.

Specifically, in the acceleration sensor of the first preferred embodiment, the output sensitivity depends on the mass of the first mass body 21 and the rigidity of the first beams 31 in the low acceleration region. On the other hand, in the high acceleration region, the output sensitivity depends on the total mass of the first mass body 21 and the second mass bodies 22 and the rigidity of the first beams 31 and that of the second beams 32.

As discussed above, in the acceleration sensor of the first preferred embodiment, each of the second mass bodies 22 held by the second beams 32 is arranged near the first mass body 21.

Therefore, wide range acceleration (both the low acceleration region and the high acceleration region) can be detected by using one acceleration sensor element 11.

Further, as shown in FIG. 5, unlike in the configuration of FIG. 3, the comb-teeth electrodes 221 and 222 may be provided on the second mass body 22. Though the area of the lower half of the first mass body 21 and the vicinity thereof is shown in FIG. 5, the same applies to the second mass body 22 facing the upper side of the first mass body 21. As shown in FIG. 5, the fixed electrodes 51 and 52 are provided additionally with comb-teeth electrodes 512 and 522. The fixed electrodes 51 and 52 are so arranged as to convert the displacement of the second mass bodies 22 into the quantity of electricity.

As shown in FIG. 5, correspondingly to the comb-teeth electrodes 221, provided are the comb-teeth electrodes 512, and the comb-teeth electrodes 221 and the comb-teeth electrodes 512 are alternately arranged in a vertical (up and down) direction of FIG. 5. Very near each of the comb-teeth electrodes 221, provided is the corresponding one of the comb-teeth electrodes 512, and each of the comb-teeth electrodes 221 and the corresponding one of the comb-teeth electrodes 512 which is provided very near the comb-teeth electrode 221 are arranged away from each other with a very small interval therebetween.

Further, as shown in FIG. 5, correspondingly to the comb-teeth electrodes 222, provided are the comb-teeth electrodes 522, and the comb-teeth electrodes 222 and the comb-teeth electrodes 522 are alternately arranged in the vertical (up and down) direction of FIG. 5. Very near each of the comb-teeth electrodes 222, provided is the corresponding one of the comb-teeth electrodes 522, and each of the comb-teeth electrodes 222 and the corresponding one of the comb-teeth electrodes 522 which is provided very near the comb-teeth electrode 222 are arranged away from each other with a very small interval therebetween.

The acceleration sensor having the configuration of FIG. 3 senses the changes of the capacitances only between one first mass body 21 and the fixed electrodes 51 and 52. On the other hand, the acceleration sensor having the configuration of FIG. 5 can sense the changes of the capacitances between a plurality of mass bodies 21 and 22 and the fixed electrodes 51 and 52.

### The Second Preferred Embodiment

In the first preferred embodiment, one second mass body 22 is so provided as to face each of the upper and lower sides of the first mass body 21. In the second preferred embodiment, however, a plurality of second mass bodies 22 (223, 224, 225, and 226) are so provided as to face each of the upper and lower sides of the first mass body 21.

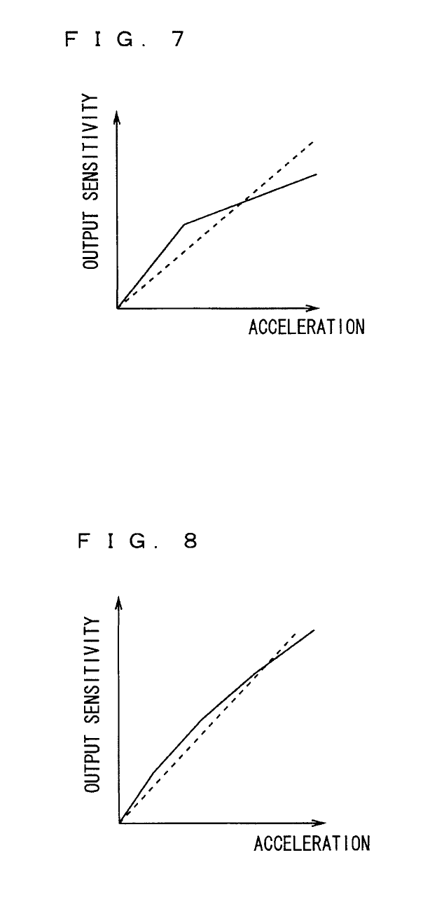

FIG. 6 is a plan view showing a configuration of an acceleration sensor in accordance with the second preferred embodiment. FIG. 6 shows only the lower half of the first mass body 21 and the vicinity thereof.

In the exemplary configuration of FIG. 6, four second mass bodies 223, 224, 225, and 226 are so provided as to face the lower side of the first mass body 21. Though not shown in FIG. 6, the second mass bodies as many as the second mass bodies 22 facing the lower side of the first mass body 21 (in the case of FIG. 6, four second mass bodies) are so provided in the same arrangement as to face the upper side of the first mass body 21. For this reason, the following description will be made on a configuration of the lower half of the first mass body 21 and the vicinity thereof, and the same applies to a configuration of the upper half of the first mass body 21 and the vicinity thereof.

The adjacent second mass bodies 223 to 226 are aligned, being away from one another with an interval therebetween in a vertical (up and down) direction of FIG. 6. To each of the second mass bodies 223 to 226, connected are two second beams 32 (321, 322, 323, and 324).

Specifically, to the second mass body 223, connected are two (a pair of) second beams 321. Similarly, two (a pair of) second beams 322 are connected to the second mass body 224, two (a pair of) second beams 323 are connected to the second mass body 225, and two (a pair of) second beams 324 are connected to the second mass body 226.

One end of each of the second beams 321, 322, 323, and 324 is connected to the corresponding one of the second mass bodies 223 to 226 and the other end of each of the second beams 321, 322, 323, and 324 is connected to the anchor 34 serving as a fixed end. One of each pair of second beams 321 to 324 is connected to one of the anchors 34 and the other one of each pair of second beams 321 to 324 is connected to the other one of the anchors 34. Further, to the one anchor 34, also connected is one of the first beams 31, and to the other anchor 34, also connected is the other one of the first beams 31.

The configuration of the acceleration sensor of the second preferred embodiment other than the above is the same as that of the acceleration sensor of the first preferred embodiment.

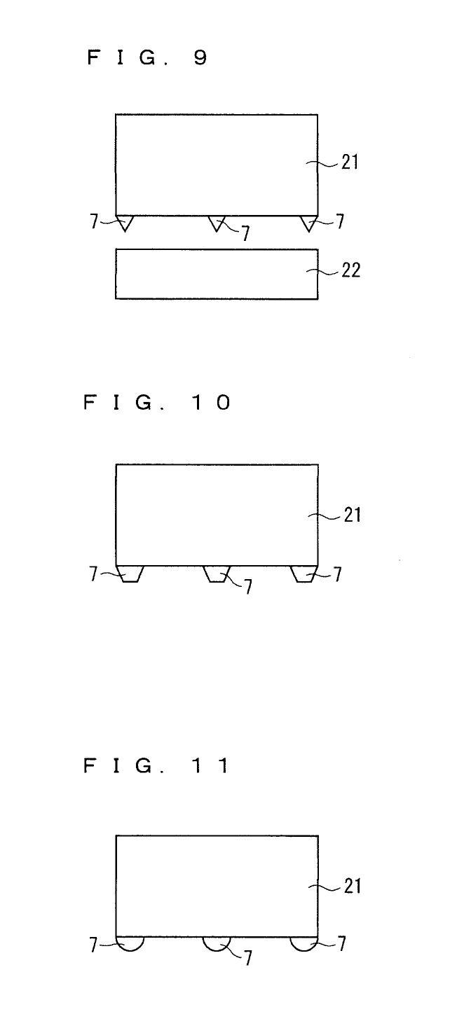

It is desirable that the output sensitivity of the acceleration sensor with respect to the acceleration should be changed linearly as indicated by the broken line in the graph of FIG. 7. In the acceleration sensor of the first preferred embodiment, one second mass body 22 is so provided as to face each of the upper and lower sides of the first mass body 21. In the exemplary configuration of the first preferred embodiment, since the rigidity of the beam is changed at the point of time when the first mass body 21 comes into contact with the second mass body 22, such output sensitivity characteristic as indicated by the solid line in the graph of FIG. 7 is obtained as that of the acceleration sensor with respect to the acceleration. FIG. 7 is a graph showing acceleration and output sensitivity characteristic of the acceleration sensor, and in the graph, the vertical axis represents the output sensitivity and the horizontal axis represents the acceleration.

On the other hand, in the acceleration sensor of the second preferred embodiment, two or more second mass bodies 223 to 226 are so provided as to face each of the upper and lower sides of the first mass body 21. With such a configuration, it is possible to make fine control of the rigidity of the beam. Therefore, such output sensitivity characteristic as indicated by the solid line in the graph of FIG. 8 is obtained as that of the acceleration sensor with respect to the acceleration. In other words, as shown in the graph of FIG. 8, the line indicating the characteristic becomes approximate to the ideal line (broken line). FIG. 8 is also a graph showing acceleration and output sensitivity characteristic of the acceleration sensor, and in the graph, the vertical axis represents the output sensitivity and the horizontal axis represents the acceleration.

Thus, in the second preferred embodiment, the number of second mass bodies 22 (223 to 226) is increased. It is therefore possible to obtain an ideal output characteristic and to thereby provide a high-precision acceleration sensor.

In the first and second preferred embodiments, the second mass bodies 22 (223 to 226) may have the same mass or different masses. Further, the second beams 32 (321 to 324) may have the same rigidity or different rigidities. In other words, it is desirable that the mass of each of the second mass bodies 22 (223 to 226) and the rigidity of each of the second beams 32 (321 to 324) should be set so that the output characteristic may become more approximate to the ideal one.

The acceleration sensor having the configuration of FIG. 6 can sense the changes of the capacitances between one first mass body 21 and the fixed electrodes 51 and 52.

### The Third Preferred Embodiment

In the first preferred embodiment, a surface of the second mass body 22 facing the first mass body 21 and a surface of the first mass body 21 facing the second mass body 22 are each flat. In the third preferred embodiment, however, projections are provided on at least one of the surface of the second mass body 22 facing the first mass body 21 and the surface of the first mass body 21 facing the second mass body 22.

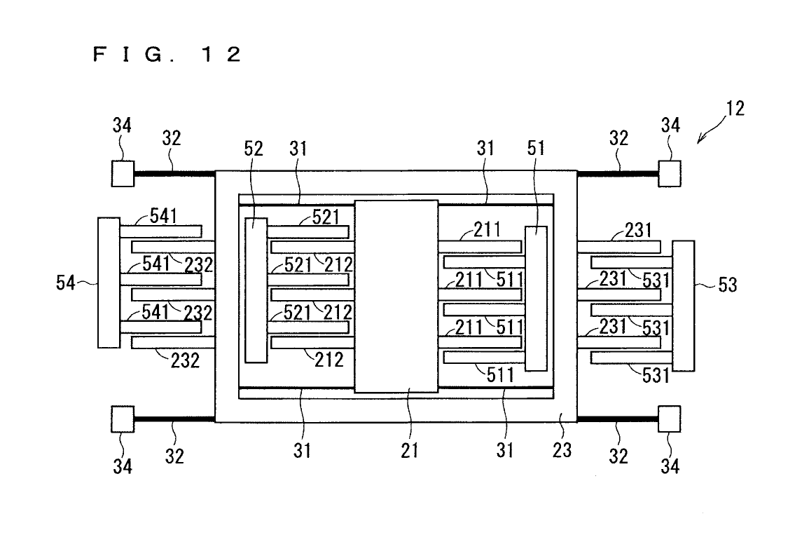

FIG. 9 is an enlarged plan view showing a configuration of a characteristic part (i.e., a portion where the first mass body 21 faces the second mass body 22) and the vicinity of an acceleration sensor in accordance with the third preferred embodiment.

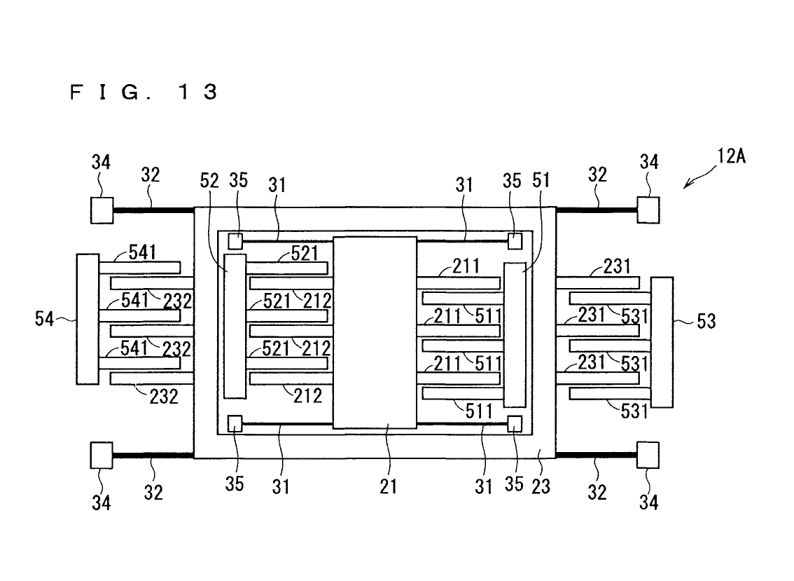

In the exemplary configuration of FIG. 9, a plurality of projections 7 each having a triangular cross section are formed on the surface of the first mass body 21 which faces the second mass body 22. Further, a plurality of projections 7 formed on the surface of the first mass body 21 facing the second mass body 22 may have a trapezoidal cross section as shown in FIG. 10. Alternatively, a plurality of projections 7 formed on the surface of the first mass body 21 facing the second mass body 22 may have a circular cross section as shown in FIG. 11.

Furthermore, though the projections 7 are formed on the surface of the first mass body 21 facing the second mass body 22 in the exemplary cases of FIGS. 9, 10, and 11, the projections 7 may be formed on the surface of the second mass body 22 facing the first mass body 21. Alternatively, the projections 7 may be formed on both the surface of the second mass body 22 facing the first mass body 21 and the surface of the first mass body 21 facing the second mass body 22.

When high acceleration is inputted to the acceleration sensor, there is apprehension that the contact between the first mass body 21 and the second mass body 22 may cause a phenomenon called “stick”. Then, in the third preferred embodiment, the projections 7 are formed on at least one of the surface of the second mass body 22 facing the first mass body 21 and the surface of the first mass body 21 facing the second mass body 22. It is therefore possible to reduce the area where the first mass body 21 and the second mass body 22 are in contact with each other and to thereby avoid the phenomenon called “stick”.

### The Fourth Preferred Embodiment

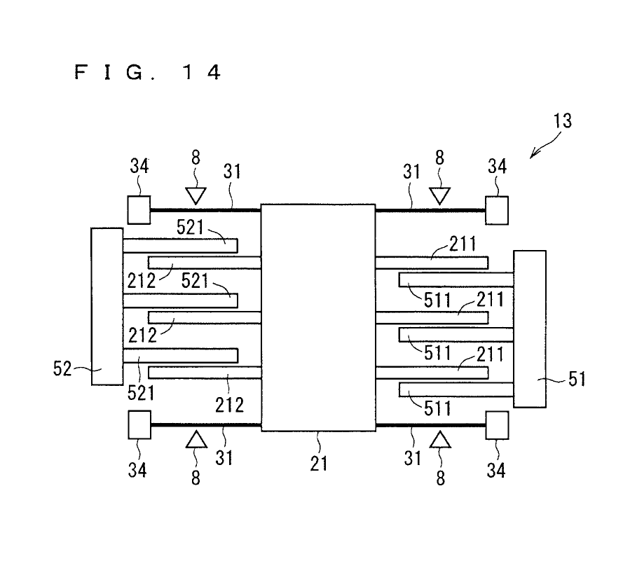

FIG. 12 is a plan view showing a configuration of an acceleration sensor in accordance with the fourth preferred embodiment.

A configuration of an acceleration sensor element 12 of the fourth preferred embodiment is different from the configuration of the acceleration sensor element 11 of the first preferred embodiment. Also in the fourth preferred embodiment, though the main board is held between the supporting substrates from the up and down directions, the supporting substrates are not shown in FIG. 12 for simple illustration.

Constituent elements of the acceleration sensor element 12 of the fourth preferred embodiment shown in FIG. 12 which are similar to or correspond to those of the acceleration sensor element 11 discussed earlier are represented by the same reference signs, and description thereof will be omitted.

Like in the acceleration sensor element 11 shown in FIG. 3, in the acceleration sensor element 12 shown in FIG. 12, the first mass body 21 (including the comb-teeth electrodes 211 and 212) and the fixed electrodes 51 and 52 (including the comb-teeth electrodes 511 and 521) are formed and arranged in the same manner.

In the acceleration sensor element 12 of the fourth preferred embodiment in a plan view, the first mass body 21 and the fixed electrodes 51 and 52 are surrounded by a second mass body 23 having a rectangular frame-like shape. In this case, the first mass body 21 and the second mass body 23 are connected to each other with four first beams 31. Specifically, each of the first beams 31 connects the first mass body 21 to an inner peripheral portion of the second mass body 23. The first mass body 21 and the second mass body 23 can be moved (in other words, can be displaced by the inputted acceleration) with the first beams 31 interposed therebetween.

Further, as shown in FIG. 12, comb-teeth electrodes 232 and 231 are provided on an outer peripheral portion of the second mass body 23 on the left and right sides in FIG. 12, respectively. Outside the second mass body 23, provided are two fixed electrodes 53 and 54. On the fixed electrode 53, comb-teeth electrodes 531 are provided correspondingly to the comb-teeth electrodes 231. On the fixed electrode 54, comb-teeth electrodes 541 are provided correspondingly to the comb-teeth electrodes 232.

In this case, the comb-teeth electrodes 231 and 531 are alternately arranged, being away from each other with a desired interval therebetween in a vertical (up and down) direction of FIG. 12, and the comb-teeth electrodes 232 and 541 are alternately arranged, being away from each other with a desired interval therebetween in the vertical (up and down) direction of FIG. 12.

The fixed electrodes 51 and 52 are so arranged as to convert the displacement of the first mass body 21 into the quantity of electricity, and the fixed electrodes 53 and 54 are so arranged as to convert the displacement of the second mass body 23 into the quantity of electricity.

Further, in the acceleration sensor element 12 of the fourth preferred embodiment, the outer peripheral portion of the second mass body 23 and the anchors 34 serving as fixed ends are connected to each other with the second beams 32. The second mass body 23 is so supported with the anchors 34 as to be displaced by the inputted acceleration. Like in FIG. 3, four anchors 34 are provided, and for each of the anchors 34, provided is one second beam 32 for supporting the second mass body 23.

As can be seen from the above-described configuration, the first mass body 21 is so supported by the anchors 34 with the first beams 31, the second mass body 23, and the second beams 32 interposed therebetween as to be displaced by the inputted acceleration.

Operation and function of the acceleration sensor element 12 of the fourth preferred embodiment shown in FIG. 12 at the time when the acceleration is inputted thereto are the same as those of the acceleration sensor element 11 discussed earlier.

Specifically, when high acceleration is inputted to the acceleration sensor element 12, the upper and lower sides of the first mass body 21 are brought into contact with the inner peripheral portion of the second mass body 23. Therefore, the mass of the second mass body 23 and the rigidity of the second beams 32 having high rigidity affect the movement (movability) of the first mass body 21. In other words, the output sensitivity of the acceleration sensor element 12 depends on the total mass of the first mass body 21 and the second mass bodies 23 and the rigidity of the first beams 31 and that of the second beams 32 in the high acceleration region. On the other hand, in the low acceleration region, the output sensitivity of the acceleration sensor element 12 depends on the mass of the first mass body 21 and the rigidity of the first beams 31.

Thus, in the acceleration sensor of the fourth preferred embodiment, the second mass body 23 held by the second beams 32 is so provided as to surround the first mass body 21.

Therefore, wide range acceleration (both the low acceleration region and the high acceleration region) can be detected by using one acceleration sensor element 12. Further, the size of the second mass body 23 used in the high acceleration region can be made larger than that of the second mass body 22. Therefore, the acceleration sensor of the fourth preferred embodiment can detect high acceleration with higher precision than the acceleration sensor of the first preferred embodiment.

In the configuration of FIG. 12, the first beams 31 connect the first mass body 21 and the second mass body 23. Alternatively, an acceleration sensor element 12A shown in FIG. 13 may be adopted.

In the acceleration sensor element 12A of FIG. 13, four anchors 35 serving as fixed ends are additionally provided. Each of the anchors 35 is fixed to and supported by the supporting substrates holding the main board. In the configuration of FIG. 13, each of the first beams 31 connects the first mass body 21 and the corresponding one of the anchors 35. In other words, in the configuration of FIG. 13, the first mass body 21 is so fixed and supported as to be displaced by the inputted acceleration with the first beams 31 and the anchors 35. Other than the connection manner of the first beams 31, there is no difference between the configuration of FIG. 12 and the configuration of FIG. 13.

The acceleration sensor shown in FIG. 13 can also produce the same effect as that of the acceleration sensor shown in FIG. 12.

The acceleration sensors having the respective configurations of FIGS. 12 and 13 can sense the changes of the capacitances between the first mass body 21 and the fixed electrodes 51 and 52 and the changes of the capacitances between the second mass body 23 and the fixed electrodes 53 and 54.

Further, in the configurations of FIGS. 12 and 13, there may be a case where the changes of the capacitances only between one first mass body 21 and the fixed electrodes 51 and 52 can be sensed by omitting the fixed electrodes 53 and 54 and the comb-teeth electrodes 231 and 232.

### The Fifth Preferred Embodiment

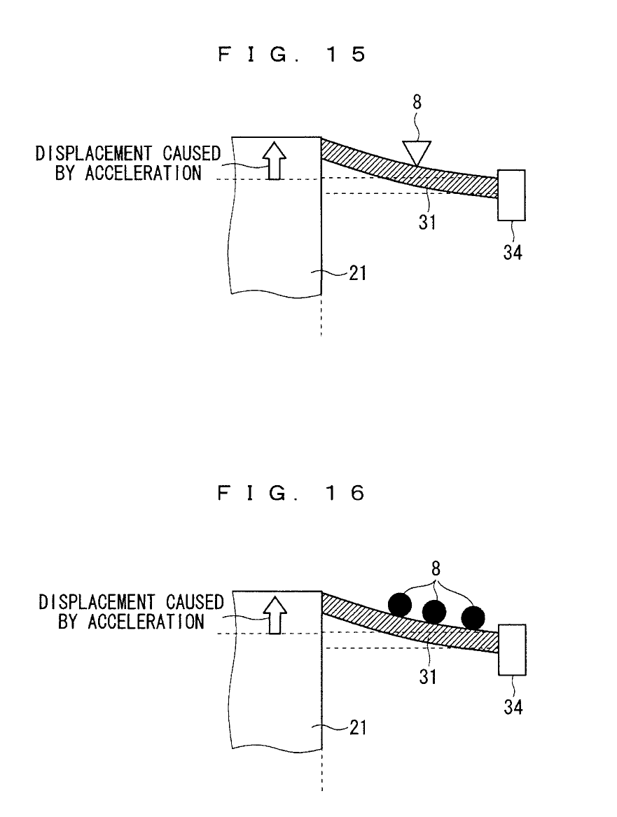

FIG. 14 is a plan view showing a configuration of an acceleration sensor in accordance with the fifth preferred embodiment.

A configuration of an acceleration sensor element 13 of the fifth preferred embodiment is different from the configuration of the acceleration sensor element 11 of the first preferred embodiment. Also in the fifth preferred embodiment, though the main board is held between the supporting substrates from the up and down directions, the supporting substrates are not shown in FIG. 14 for simple illustration.

Constituent elements of the acceleration sensor element 13 of the fifth preferred embodiment shown in FIG. 14 which are similar to or correspond to those of the acceleration sensor element 11 discussed earlier are represented by the same reference signs, and description thereof will be omitted.

Like in the acceleration sensor element 11 shown in FIG. 3, in the acceleration sensor element 13 shown in FIG. 14, the first mass body 21 (including the comb-teeth electrodes 211 and 212) and the fixed electrodes 51 and 52 (including the comb-teeth electrodes 511 and 521) are formed and arranged in the same manner.

Also in the acceleration sensor element 13 of the fifth preferred embodiment, the first mass body 21 is connected to the anchors 34 with the first beams 31, respectively, and the first mass body 21 is so supported by the anchors 34 with the first beams 31 interposed therebetween as to be displaced by the inputted acceleration.

In the acceleration sensor element 13 of the fifth preferred embodiment, the second mass bodies 22 and the second beams 32 are omitted, unlike in the acceleration sensor element 11 discussed earlier. In the acceleration sensor element 13 of the fifth preferred embodiment, instead, provided are columns 8. As shown in FIG. 14, the columns 8 are provided correspondingly to the first beams 31, and each of the columns 8 is arranged near the corresponding one of the first beam 31.

In the fifth preferred embodiment, the columns 8 arranged near the first beams 31 serve as the displaceability changing member discussed in the first preferred embodiment.

In the configuration of FIG. 14, the column 8 provided near the first beam 31 is arranged on one side of the first beam 31 at some midpoint thereof. Unlike in the configuration of FIG. 14, however, the column 8 provided near the first beam 31 may be arranged on both sides of the first beam 31 at some midpoint thereof.

In this case, the columns 8 are fixed to both or either of the supporting substrates not shown in FIG. 14.

FIG. 15 is an enlarged plan view showing the first beam 31 and the vicinity thereof. With reference to FIG. 15, discussion will be made on an operation of the acceleration sensor of the fifth preferred embodiment.

When acceleration is inputted to the acceleration sensor of the fifth preferred embodiment, the first mass body 21 is displaced in a vertical (up and down) direction of FIG. 15. In this case, when certain or higher acceleration is inputted, the first mass body 21 is largely displaced and the first beam 31 is brought into contact with the column 8 positioned near the first beam 31 (see FIG. 15). After the contact, the length of the first beam 31 which affects the displacement (displaceability) of the first mass body 21 becomes seemingly shorter and the rigidity thereof becomes higher than those before the contact.

In the acceleration sensor of the fifth preferred embodiment, the first beam 31 is out of contact with the column 8 in the low acceleration region, and the first beam 31 comes into contact with the column 8 and the rigidity of the first beam 31 becomes higher in the high acceleration region. As a result, the acceleration sensor of the fifth preferred embodiment can sense wide range acceleration.

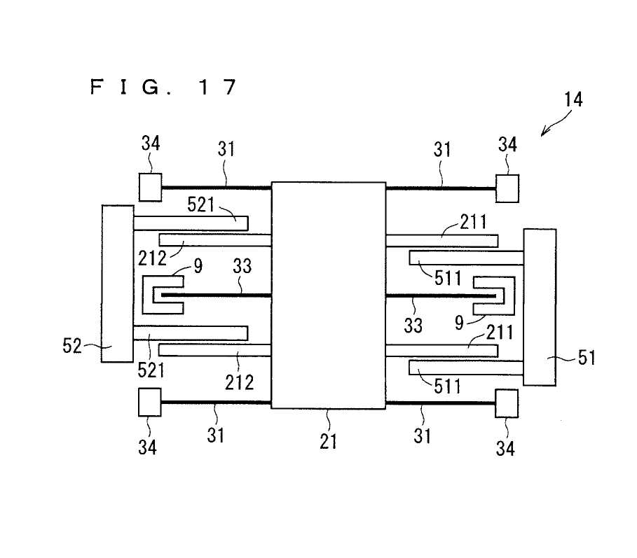

In the configuration of FIG. 15, only one column 8 is provided for one first beam 31 on one side thereof. On the other hand, as shown in FIG. 16, a plurality of (in FIG. 16, three) columns 8 may be provided for one first beam 31 on one side thereof along a direction in which the first beam 31 extends.

Though a plurality of columns 8 are arranged on one side of the first beam 31 in FIG. 16, a plurality of columns 8 may be arranged on both sides of the first beam 31 along the direction in which the first beam 31 extends.

Further, though the shape of the column 8 in a plan view is a triangle in FIG. 15, the shape of the column 8 in a plan view is not limited to this but may be a circle as shown in FIG. 16.

As shown in FIG. 16, by increasing the number of columns 8 arranged near each of the first beams 31, it is possible to make finer control of the rigidity of the beam. Therefore, in the acceleration sensor having the configuration shown in FIG. 16, the output sensitivity characteristic can be made more approximate to such ideal one as indicated by the line (broken line) of FIG. 8.

### The Sixth Preferred Embodiment

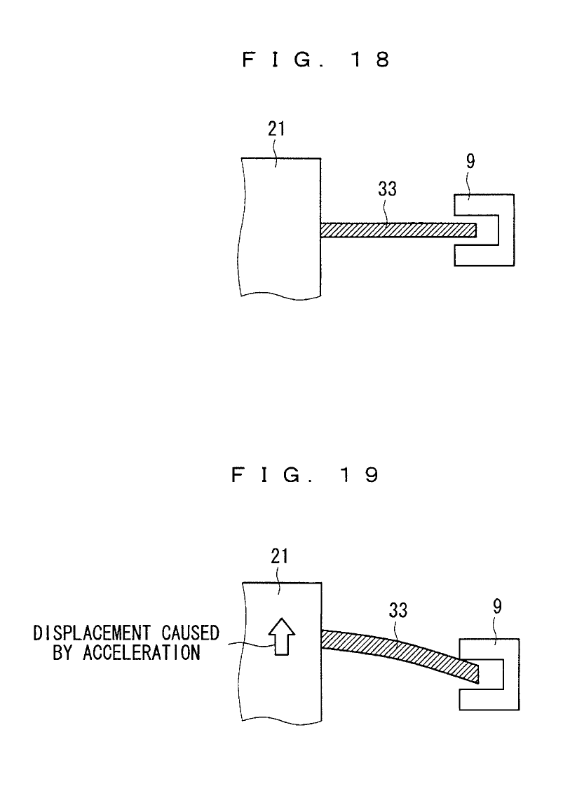

FIG. 17 is a plan view showing a configuration of an acceleration sensor in accordance with the sixth preferred embodiment.

A configuration of an acceleration sensor element 14 of the sixth preferred embodiment is different from the configuration of the acceleration sensor element 11 of the first preferred embodiment. Also in the sixth preferred embodiment, though the main board is held between the supporting substrates from the up and down directions, the supporting substrates are not shown in FIG. 17 for simple illustration.

Constituent elements of the acceleration sensor element 14 of the sixth preferred embodiment shown in FIG. 17 which are similar to or correspond to those of the acceleration sensor element 11 discussed earlier are represented by the same reference signs, and description thereof will be omitted.

Like in the acceleration sensor element 11 shown in FIG. 3, in the acceleration sensor element 14 shown in FIG. 17, the first mass body 21 (including the comb-teeth electrodes 211 and 212) and the fixed electrodes 51 and 52 (including the comb-teeth electrodes 511 and 521) are formed and arranged in the same manner.

Also in the acceleration sensor element 14 of the sixth preferred embodiment, the first mass body 21 is connected to the anchors 34 with the first beams 31, respectively, and the first mass body 21 is so supported by the anchors 34 with the first beams 31 interposed therebetween as to be displaced by the inputted acceleration.

In the acceleration sensor element 14 of the sixth preferred embodiment, the second mass body 22 and the second beams 32 are omitted, unlike in the acceleration sensor element 11 discussed earlier. In the acceleration sensor element 14 of the sixth preferred embodiment, instead, provided are second beams 33 and beam surrounding portions 9.

As shown in FIG. 17, one end of each of the second beams 33 of the sixth preferred embodiment is connected to the first mass body 21. Further, as shown in FIG. 17, in a static state of the first mass body 21, the other end of the second beam 33 is surrounded by the beam surrounding portion 9 in a plan view. In other words, in the static state of the first mass body 21, the other end of the second beam 33 is free, being in contact with no member (that is, the other end of the second beam 33 is not supported by nor fixed to the supporting substrates).

As shown in FIG. 17, the beam surrounding portion 9 has a squared U-shape in a plan view and surrounds not only the other end of the second beam 33 but also both sides of part of the second beam 33 which is connected to the other end. In the exemplary configuration of FIG. 17, one second beam 33 is provided from each of the right and left side surfaces of the first mass body 21 and one beam surrounding portion 9 is provided for each of the second beams 33.

In the sixth preferred embodiment, the beam surrounding portions 9 surrounding the other ends of the second beams 33 and the vicinity thereof serve as the displaceability changing member discussed in the first preferred embodiment.

Each of the beam surrounding portions 9 is so formed as to extend in a front and back direction of FIG. 17 and fixed to both or either of the supporting substrates not shown in FIG. 17.

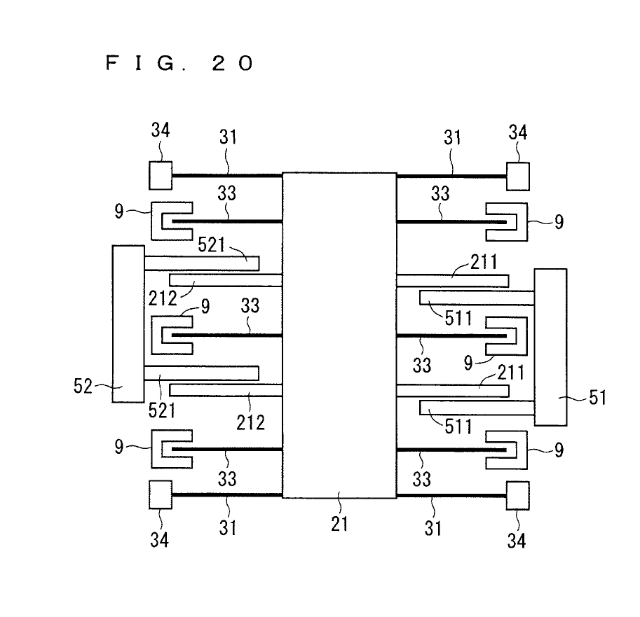

FIGS. 18 and 19 are enlarged plan views showing the second beam 33 and the vicinity thereof. With reference to FIGS. 18 and 19, discussion will be made on an operation of the acceleration sensor of the sixth preferred embodiment.

When no acceleration is inputted to the acceleration sensor of the sixth preferred embodiment or low acceleration is inputted thereto, the other end of the second beam 33 serves as a free end, being away from the beam surrounding portion 9 as shown in FIG. 18.

When certain or higher acceleration is inputted to the acceleration sensor of the sixth preferred embodiment, the first mass body 21 is largely displaced in a vertical (up and down) direction of FIG. 19. Then, the other end of the second beam 33 is brought into contact with the beam surrounding portion 9 as shown in FIG. 19. After the contact, both the first and second beams 31 and 33 affect the displacement (displaceability) of the first mass body 21 and the rigidity of all the beams becomes higher than that before the contact.

In the other words, in the acceleration sensor of the sixth preferred embodiment, the second beam 33 is out of contact with the beam surrounding portion 9 in the low acceleration region and only the first beam 31 affects the displacement (displaceability) of the first mass body 21. On the other hand, in the high acceleration region, the second beam 33 comes into contact with the beam surrounding portion 9 and both the first beam 31 and the second beam 33 affect the displacement (displaceability) of the first mass body 21. As a result, the acceleration sensor of the sixth preferred embodiment can sense wide range acceleration.

In the configuration of FIG. 17, one second beam 33 is provided from each of the right and left side surfaces of the first mass body 21. On the other hand, there may be another configuration shown in FIG. 20 where a plurality of (in FIG. 20, three) second beams 33 are provided from each of the right and left side surfaces of the first mass body 21 and one beam surrounding portion 9 is provided for each of the second beams 33.

As shown in FIG. 20, by increasing the number of second beams 33 and the number of beam surrounding portions 9 provided correspondingly to the second beams 33, it is possible to make finer control of the rigidity of the beam. Therefore, in the acceleration sensor having the configuration shown in FIG. 20, the output sensitivity characteristic can be made more approximate to such ideal one as indicated by the line (broken line) of FIG. 8.

While the invention has been shown and described in detail, the foregoing description is in all aspects illustrative and not restrictive. It is therefore understood that numerous modifications and variations can be devised without departing from the scope of the invention.

What is claimed is:

1. An acceleration sensor comprising:
a first mass body which is held by a first beam and can be displaced by acceleration;
a fixed electrode which is so arranged as to convert said displacement of said first mass body into the quantity of electricity; and
a displaceability changing member for changing displaceability of said first mass body when said displacement of said first mass body exceeds a predetermined range.

2. The acceleration sensor according to claim 1, wherein
said displaceability changing member is a second mass body which is held by a second beam and can be displaced by acceleration, being arranged away from said first mass body with a predetermined interval therebetween.

3. The acceleration sensor according to claim 2, wherein
a plurality of said second beams and a plurality of said second mass bodies are provided, and
each of said plurality of second mass bodies is held by a corresponding one of said plurality of different second beams.

4. The acceleration sensor according to claim 3, wherein
said plurality of second mass bodies have the same mass, and
said plurality of second beams have the same rigidity.

5. The acceleration sensor according to claim 3, wherein
said plurality of second mass bodies have different masses, and
said plurality of second beams have different rigidities.

6. The acceleration sensor according to claim 2, wherein
a projection is formed on said second mass body facing said first mass body or on said first mass body facing said second mass body.

7. The acceleration sensor according to claim 2, wherein
said second mass body surrounds said first mass body in a plan view.

8. The acceleration sensor according to claim 7, wherein
said first beam connects said first mass body to said second mass body, and
said second beam connects said second mass body to an anchor serving as a fixed end.

9. The acceleration sensor according to claim 7, wherein
said first beam connects said first mass body to a first anchor serving as a fixed end, and
said second beam connects said second mass body to a second anchor serving as a fixed end.

10. The acceleration sensor according to claim 2, wherein
the change of a capacitance only between said first mass body and said fixed electrode is sensed.

11. The acceleration sensor according to claim 2, wherein
said fixed electrode is so arranged as to convert said displacement of said second mass body into the quantity of electricity, and
both the change of a capacitance between said first mass body and said fixed electrode and the change of a capacitance between said second mass body and said fixed electrode are sensed.

12. The acceleration sensor according to claim 1, wherein
said displaceability changing member is a column arranged near said first beam.

13. The acceleration sensor according to claim 12, wherein
a plurality of said columns are arranged along a direction in which said first beam extends.

14. The acceleration sensor according to claim 1, wherein
said first beam connects said first mass body to an anchor serving as a fixed end,
said acceleration sensor further comprising
a second beam of which one end is connected to said first mass body,
wherein said displaceability changing member is a beam surrounding portion surrounding the other end of said second beam and both sides of part of said second beam near the other end thereof.

15. The acceleration sensor according to claim 14, wherein
a plurality of said second beams and a plurality of said beam surrounding portions are provided, and
one of said plurality of beam surrounding portions is provided for each of the other ends of said plurality of second beams.
